(19) United States
(12) Patent Application Publication
(10) Pub. No.: US 2014/0153353 A1
(43) Pub. Date: Jun. 5, 2014

(54) METHOD AND AN APPARATUS FOR ADDING AN ADDITIVE TO A CEMENT-LIKE COMPOSITION

(71) Applicants: Jan-Erik Teirfolk, Turku (FI); Timo Koskinen, Valkeakoski (FI); Sirkka Gustafsson, Kangasala (FI)

(72) Inventors: Timo Koskinen, Valkeakoski (FI); Helmer Gustafsson, Kangasala (FI); Jan-Erik Teirfolk, Turku (FI)

(73) Assignee: UPM-KYMMENE CORPORATION, Helsinki (FI)

(21) Appl. No.: 14/113,019

(22) PCT Filed: Apr. 20, 2012
(86) PCT No.: PCT/FI12/50394

§ 371 Date: Dec. 19, 2013

(30) Foreign Application Priority Data
Apr. 20, 2011 (FI) 20115386

(51) Int. Cl. B28C 7/04; B28C 5/40

(52) U.S. Cl. CPC B28C 7/04; B28C 5/402
USPC 366/3; 366/10

(57) ABSTRACT

Disclosed is a method for adding an additive to a cement-like composition, preferably a concrete mixture. The method includes forming a liquid flow, preferably a water flow; feeding an additive to the system; dosing said additive to said liquid flow by feeding it transversely and/or counter-currently to the liquid flow in such a way that mixture is formed which includes said additive and nanocellulose; and adding the formed mixture as an additive to a cement-like composition. Furthermore, disclosed is a cement-like composition and to an apparatus for adding an additive to a cement-like composition.

### FIELD OF THE INVENTION

The invention relates to a method and an apparatus for adding an additive to a cement-like composition. In particular, the invention relates to a method for adding nanocellulose to a cement-like composition. Furthermore, the invention relates to a product made by the method.

### BACKGROUND OF THE INVENTION

Concrete is a construction material made of a mixture of cement, sand, rock, and water. Concrete is solidified and hardened after the mixing with water and casting, by a chemical process called hydration. Water reacts with cement which binds the other ingredients together, wherein a stone-like material is finally formed. Concrete is used for constructing pavements, architectural structures, foundations, motorways/roads, bridges/level crossings, parking constructions, brick/element walls, as well as basement slabs for gates, fences and columns.

In concrete technology, an important and interesting field is self-compacting concrete (SCC) which is automatically spread and consolidated by gravity. Consequently, no external vibration or other compacting is needed. The hardened concrete functions like normal concrete in a structure. Self-compacting concrete can be used to make very high quality concrete. Because no compacting work is needed, the noise level during the construction is significantly reduced, and one work stage is eliminated. In self-compacting concrete, segregation may take place, which may be segregation of either water or aggregate. Variations in the composition or moisture content of the raw material may change the behaviour of the self-compacting concrete even to a significant extent. This lack of robustness restricts the application of self-compacting concrete in some uses.

Injection mortars are intended for use in connection with injection technologies. Properties required of these materials include e.g. the necessary liquidity and low segregation of water. Additives can be used for changing the properties of the concrete material.

### BRIEF SUMMARY OF THE INVENTION

It is an aim of this invention to present a new method and apparatus for adding an additive, particularly nanocellulose, in a cement-like composition. Adding nanocellulose evenly to various mixtures is challenging. Because of the properties and particularly the fast drying of the cement mixture, for example concrete, the manufacturing stage may only take a short time, typically only a few minutes. This may cause additional challenges in view of the homogeneous mixing of the additive.

To achieve the aim of the invention, according to an advantageous embodiment, the method comprises:
forming a liquid flow,
supplying additive to the system,
dosing said additive to said liquid flow by supplying it to the liquid flow in a direction substantially transverse to the flowing direction of said liquid flow, in such a way that a mixture is formed which comprises liquid and the additive, and
adding the formed mixture as an additive to a cement-like composition.

Preferably, thanks to the feeding method, said additive is mixed substantially over the whole cross-sectional area of the liquid flow.

According to another embodiment, the method comprises
forming a liquid flow,
feeding additive to the system,
dosing said additive to said liquid flow by feeding it to the liquid flow substantially counter-currently to the flowing direction of said liquid flow, in such a way that a mixture is formed which comprises said additive and liquid, and
adding the formed mixture as an additive to a cement-like composition.

Preferably, thanks to the feeding method, said additive is mixed substantially over the whole cross-sectional area of the liquid flow.

According to an advantageous example, the additive comprising nanocellulose, the nanocellulose may have a solid content of, for example, about 2% when supplied to the liquid flow. According to an advantageous example, the nanocellulose has a solid content of 0.5 to 5%, more advantageously 1 to 3%, when supplied to the liquid flow.

A separate injection fluid can also be used to assist in the addition of the additive, advantageously nanocellulose. Thus, according to an example, the mixing of the additive to the liquid flow is intensified in such a way that the means for adding the additive, for example the means for adding nanocellulose, comprises not only a feed channel but also a separate injection fluid feed channel, for supplying the additive by means of the injection fluid to the flow channel. According to an advantageous example, the injection fluid feed channel consists of a side flow channel connected to the flow channel and arranged to take in fluid from the flow channel and to convey it back to the flow channel via a nozzle.

According to an advantageous example, thanks to the transverse addition of the additive, such as the injection of nanocellulose, the homogeneous mixing of said additive (for example nanocellulose) into said liquid flow takes place in an intensive mixing zone, which is at and immediately after the dosing point in the flowing direction of the liquid flow. The mixing becomes particularly efficient, if the feeding rate of the nanocellulose mixture to be added is higher than the liquid flow rate. Instead of or in addition to said transverse addition of the additive, in an example, the additive is supplied counter-currently to the liquid flow. Also in this case, the homogeneous mixing of the additive into the liquid flow may take place in the intensive mixing zone which is at and immediately downstream of the dosing point in the flowing direction of the liquid flow. The feeding rate of the additive to be fed is, also in this case, advantageously higher than the liquid flow rate.

According to an advantageous example, when nanocellulose is used as the additive, the nanocellulose mixed evenly to a separate liquid flow by the method of the invention is led further forward to be admixed to a concrete mixture and/or cement in such a way that at least part of the water used for preparing the material has been replaced with said nanocellulose/liquid mixture. In an advantageous example, the nanocellulose/water solution makes up at least 60% or at least 70%, more advantageously at least 80% or at least 90%, and most advantageously at least 95% or at least 98% of the total content of water used for preparing the cement-like composition, such as concrete mixture and/or cement. According to an advantageous example, the nanocellulose/water solution is the only or substantially the only water used for preparing the cement-like composition, such as concrete mixture and/or cement. It is possible to act in a corresponding manner also when applying another additive than nanocellulose.

An apparatus for adding an additive to a cement-like composition is, in an advantageous embodiment, primarily characterized in that it comprises:
a liquid flow channel,
means for supplying additive to said liquid flow channel,
a dosing point in said flow channel, comprising one or more feeding means opening into the flow channel and directed substantially transversely to the flow direction of said liquid flow and arranged to feed said additive in such a way that the additive is mixed at the dosing point preferably over the whole cross-sectional area of the flow, to form a mixture comprising additive and liquid, and
mixing means for mixing the mixture to a cement-like composition.

The apparatus according to the invention thus comprises a dosing point in the flow channel, comprising one or more adding means, such as a nozzle, opening into the flow channel and directed transversely to the flowing direction of said liquid flow, and arranged to add, preferably to inject, said additive in such a way that it is mixed preferably substantially over the whole cross-sectional area of the flow at the dosing point.

Along the liquid flow channel, the apparatus may comprise successive dosing points of the above-described kind, advantageously comprising adding means connected to a dosing container and arranged to feed and mix said additive into the liquid flow in the flow channel.

By the method of the invention, very small quantities of an additive, advantageously nanocellulose, can be added homogeneously into a cement-like composition, such as a concrete mixture and/or cement. In an example, nanocellulose is used as the additive in such a way that the content of nanocellulose is 0.002 to 2 weight percent (wt-%), more advantageously not more than 0.2 wt-% and most advantageously not more than 0.05 wt-% of the finished concrete mixture and/or cement.

By means of additives, particularly nanocellulose, it is possible to substantially improve the properties of, for example, concrete to be made. The method and the apparatus according to the invention make it possible to make a product of uniform quality. If several feeding means are used at the dosing point, on different sides of the channel, for example two feeding means opposite each other, it is possible to intensify the mixing of the additive at the dosing point.

The method according to the present invention is primarily characterized in what will be presented in claims 1 and 15. The apparatus according to the present invention is primarily characterized in what will be presented in the characterizing part of claim 10.

### DESCRIPTION OF THE DRAWINGS

The invention will be described in the following with reference to the appended drawings, in which:

FIG. 1 shows the method according to the invention in a reduced chart,

FIG. 2 shows a nanocellulose dosing and mixing point in more detail, and

FIGS. 3 to 12 illustrate results from test runs.

### DETAILED DESCRIPTION OF THE INVENTION

Unless otherwise mentioned, the terms used in the description and the claims have the meanings generally used in the building trade as well as in the pulp and paper industry. In particular, the following terms have the meanings presented below.

In the invention, a cement-like composition is made by a novel method, in which method an additive is added to the cement-like composition. The term “cement-like compositions” refers to materials consisting of cement-like adhesive and at least water. Such materials include, for example, concrete, building mortars, and jointing mortar. Normally, for example concrete consists of cement, water, aggregate, and in many cases also additives.

In the manufacture of concrete, aggregates are typically added, normally coarse aggregate and fine aggregate, as well as chemical additives. The term “aggregate” refers to granular material suitable for use in concrete. Aggregates can be materials of natural origin, synthetic, or recycled materials which have been used previously in construction. Aggregates for concrete include coarse aggregates, such as gravel, limestone or granite, and fine aggregates include sand. Crushed stone chips or recycled concrete chips can also be used as aggregates. In the invention, it is possible to use coarse aggregate and/or fine aggregate. The term “coarse aggregate” refers to aggregate whose greatest dimension is greater than or equal to 4 mm and whose smallest dimension is greater than or equal to 2 mm. The term “fine aggregate” refers to aggregate whose greatest dimension is smaller than or equal to 4 mm.

The term concrete mixture refers in this application to a raw material mixture used for making concrete.

Cements include, but not solely, common Portland cements, rapid-hardening or very rapid-hardening, sulphate-resisting concretes, modified cements, aluminium cements, high aluminium cements, calcium aluminate cements, as well as cements which contain additives, such as fly ash, Pozzolana, and the like. In the invention, it is also possible to use other cement-like materials, such as fly ash and slag cement, instead of cement.

The term “self-compacting concrete” and also the terms “self-consolidating concrete” or SCC refer to highly flowable, non-segregating concrete that spreads into place, fills the formwork and encapsulates even the tightest reinforcement without mechanical vibration. According to the definition, it is a concrete mixture that can be spread purely by its own weight without vibration. According to an advantageous example, the cement-like composition to be made in the invention is self-compacting concrete.

The term “additive in a cement-like composition” or “additive in cement/concrete” refers to a substance that has been added in small quantities with respect to the cement to a cement-like composition, such as a concrete mixing process, to change the properties of the fresh or hardened concrete. The concrete mixture according to the invention may comprise so-called cement-like additive. The term “cement-like additive” refers to any inorganic materials comprising calcium, aluminium, silicon, oxygen, and/or sulphur compounds with sufficient aqueous activity to solidify or harden in the presence of water.

Liquid flow refers in this application to any liquid-based, most generally water-based flow in which the liquid acts as a carrying medium. Preferably, the liquid flow is a water flow.

According to an advantageous example, nanocellulose from cellulosic raw material is used as an additive in the invention. The term “cellulosic raw material” refers to any cellulosic raw material source which can be used for the manufacture of cellulose pulp, refined pulp, or microfiber cellulose. The raw material can be based on any plant raw material which contains cellulose. The raw material can also be obtained from certain fermentation processes of bacteria. The plant material may be wood. The wood may be softwood, such as spruce, pine, silver fir, larch, Douglas fir, or Canadian hemlock; or hardwood, such as birch, aspen, poplar, alder, eucalyptus, or acacia; or a mixture of softwood and hardwood. Other than wood-based raw materials may include agricultural waste, grasses or other plant materials, such as straw, leaves, bark, seeds, legumes, flowers, tops, or fruit, which have been obtained from cotton, corn, wheat, oat, rye, barley, rice, flax, hemp, Manila hemp, sisal hemp, jute, ramee, kenaf hemp, bagasse, bamboo, or reed. The origin of the cellulosic raw material could also be a cellulose producing microorganism. The microorganisms may belong to the genus Acetobacter, Agrobacterium, Rhizobium, Pseudomonas, or Alcaligenes, preferably the genus Acetobacter and more advantageously the species Acetobacter xylinum or Acetobacter pasteurianus.

The term “nanocellulose” refers to a group of separate cellulose microfibrils or microfibril bundles from a cellulosic raw material. The microfibrils normally have a high aspect ratio: the length may be greater than one micrometre, whereas the number-average diameter is normally smaller than 200 nm. The diameter of the microfibril bundles may also be greater, but it is usually smaller than 1 μm. The smallest microfibrils are similar to so-called elementary fibrils which normally have a diameter of 2 to 12 nm. The dimensions of the fibrils or fibril bundles depend on the raw material and the pulping method. Nanocellulose may also contain hemicelluloses; the content will depend on the plant source. Mechanical pulping of nanocellulose from cellulosic raw material, cellulose pulp or refined pulp is implemented by suitable means, such as a refiner, a defibrator, a homogenizer, a colloid mixer, a friction grinder, an ultrasonicator, a fluidizer, such as a microfluidizer, a macrofluidizer, or a fluidizer-type homogenizer. “Nanocellulose” may also be separated directly from certain fermentation processes. The cellulose-producing microorganism according to the present invention may belong to the genus Acetobacter, Agrobacterium, Rhizobium, Pseudomonas, or Alcaligenes, preferably the genus Acetobacter and more advantageously the species Acetobacter xylinum or Acetobacter pasteurianus. The “nanocellulose” may also be any chemically or physically modified derivative of cellulose microfibrils or microfibril bundles. The chemical derivative could be based on, for example, a carboxymethylation, oxylation, esterification, or etherification reaction of cellulose molecules. The modification could also be implemented by physical adsorption of anionic, cationic or non-ionic substances or any combination of these onto the surface of cellulose. The described modification can be performed before, after, or during the production of nanocellulose.

There are several widely used synonyms for nanocellulose, for example: microfibril cellulose, nanofibrillated cellulose (NFC), nanofibril cellulose, cellulose nanofibre, nanoclass fibrillated cellulose, microfibrillated cellulose (MFC), or cellulose microfibrils. Furthermore, microfibril cellulose produced by certain microbes also has various synonyms, for example bacterial cellulose, microbial cellulose (MC), biocellulose, nata de coco (NDC) or coco de nata. The microfibril cellulose described in this invention is not of the same material as so-called cellulose whiskers, which are also called cellulose nanowhiskers, cellulose nanocrystals, cellulose nanorods, rod-like cellulose microcrystals, or cellulose nanofilaments. In some cases, similar terms are used for both materials, for example in the article Kuthcarlapati ym. (Metals Materials and Processes 20(3):307-314, 2008), where the examined material was called “cellulose nanofibre”, although cellulose nanowhiskers were obviously meant. Normally, these materials do not have amorphous segments in the fibril structure as in microfibrillated cellulose, which produces a more rigid structure. Moreover, cellulose whiskers are typically shorter than microfibrillated cellulose.

In this application, the term “substantially transverse” refers to an angle of 70 to 110°, more advantageously 80 to 100°, even more advantageously 85 to 95°, and most advantageously 87 to 93°, to said object. For example, the dosage of additive to the liquid flow substantially transversely to the flow direction of said liquid flow refers to an angle of 70 to 110°, more advantageously 80 to 100°, even more advantageously 85 to 95°, and most advantageously 87 to 93°, to the flow direction of said liquid flow.

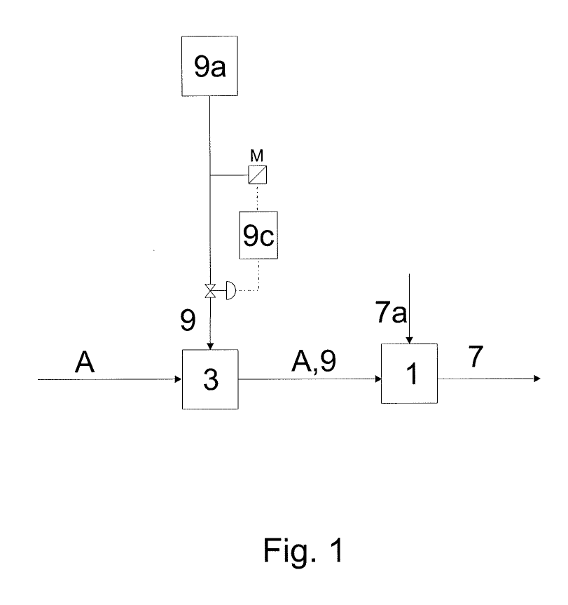

In this application, reference is made to FIGS. 1 to 12, in which the following reference symbols are used:
A liquid flow,
B flow channel, for example a pipe,
M measurement
1 preparation means for preparing a cement-like composition, such as concrete,
3 dosing and mixing point,
3a feed means, for example a nozzle,
3b injection fluid feed channel,
7a raw material(s) for the cement-like composition,
7 cement-like composition, such as concrete mixture,
9 additive, advantageously nanocellulose,
9a container or corresponding structure for storage prior to feeding the additive,
9b feed line for additive, advantageously nanocellulose, and
9c dosing unit for additive, advantageously nanocellulose.

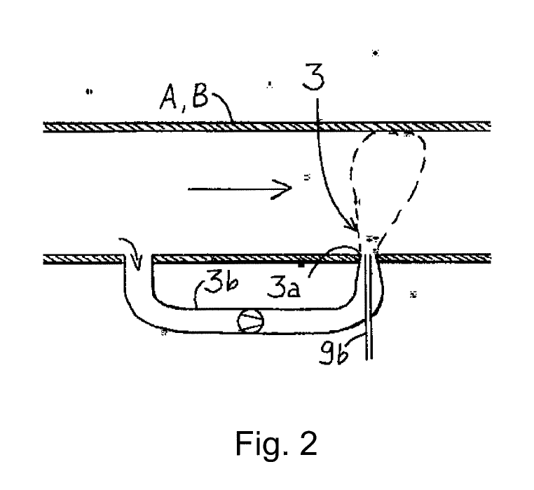

FIG. 1 shows, in a reduced chart, the method according to the invention, in which additive 9, advantageously comprising nanocellulose, is supplied to a liquid flow A, after which the formed mixture A, 9 is led to preparing means 1, to be used in the preparation of a cement-like mixture 7, such as a concrete mixture. In the solution according to FIG. 1, it is possible to use or not to use a separate additive dosing unit 9c. FIG. 2, in turn, shows a more detailed structure of a dosing and mixing point 3 according to an embodiment.

In the invention, additive 9 is dosed to a liquid flow A, advantageously a water flow, at a dosing and mixing point 3 by feeding it at a predetermined consistency to the flow A. Said predetermined consistency is advantageously 0.05 to 5%, more advantageously 0.5 to 2%. Preferably, the additive 9 is fed to the liquid flow A substantially transversely (perpendicularly) to the flow direction of the liquid A, to mix the additive 9, preferably nanocellulose, over the whole cross-sectional area of the flow A at the dosing point 3. In addition to or instead of the transverse addition of the additive, additive 9 can be fed to the liquid flow A counter-currently to the flow direction of the liquid A.

In the method according to the invention, the additive 9 is fed from a feeding means, such as a feed nozzle, at a sufficient pressure, so that the additive 9 is evenly mixed with the flow A. In this way, the mixing typically takes place very quickly, in practice typically in less than a second. One or more feeding means 3a (for example feed nozzles) can be installed in the wall of the flow channel B (for example pipe) conveying the flow A, to open in a direction substantially transverse to the longitudinal direction of the flow channel B, towards the inside of the flow channel B. If there are more than one feed means 3a, they can be evenly distributed on the circumference of the flow channel B, for example in the case of two feed means 3a in such a way that the additive 9, preferably nanocellulose, is fed from opposite directions to the liquid flow A. It is also possible to use more feeding means 3a at the dosing point 3, on different sides of the flow channel B, for example two nozzles which are preferably opposite to each other on different sides of the flow channel B. In this way, it is possible to intensify the mixing of the additive 9 at the dosing point 3.

Thanks to the addition of the additive according to the invention, for example nanocellulose 9 is evenly mixed with the liquid flow A in the zone of intensive mixing which is at and immediately after the dosing point 3 in the flow direction of the liquid flow. The mixing of the additive with the liquid flow becomes particularly efficient, if the feed rate of the additive to be injected is at least three times the liquid flow rate, expressed in linear rates.

To increase the feed rate of the additive 9 in the feed line 9b to a sufficiently high level required for the mixing, it is also possible to use an injection fluid which is pumped into the pipe and is fed from the same feed means 3a (for example nozzle) as the additive, for example nanocellulose dispersion. Thus, according to an advantageous example, the injection fluid feed channel 3b is a side flow which is separated from the liquid flow A (main flow) to be processed, and is recombined with the liquid flow (main flow) A at the dosing point 3. This is illustrated in FIG. 2, which shows how the injection fluid is advantageously obtained from the liquid flow A by connecting to the channel (pipe B) a side flow acting as said injection fluid feed channel 3b.

In an example, a sufficient feed pressure for the injection fluid in the injection fluid feed channel 3b can be obtained by a small auxiliary pump shown in FIG. 2 and provided in the injection fluid feed channel 3b (or side flow channel) to make the injection fluid flow at a sufficient rate through the nozzle 3b back to the flow channel (pipe) B. The volume of the flow to be led as a side flow through the nozzle 3a is only a fraction of the volume of the main flow A. According to the invention, the mixing of the additive 9 to the fluid flow A before the dosing of said additive, such as nanocellulose, to the concrete mixture can thus be performed at a relatively low pressure, by using only a small side flow, for example smaller than 10 volume percent (vol %), advantageously smaller than 5 vol % of the total flow of the liquid to be processed.

According to an advantageous example, the injection fluid feed channel 3b opens, as shown in FIG. 2, to the flow channel B together with an additive feed pipe 9b so that together they constitute the structure of the feed means (the nozzle structure). Thus, the feed means 3a preferably consists of concentrically opening ends of the additive feed pipe 9b and injection fluid feed pipe 3b on the inner wall of the flow channel B so that the end of the injection fluid feed channel 3b encircles the end of the feed pipe 9b in a ring-like manner. Furthermore, the terminal end of the injection fluid feed channel 3b is preferably tapering, to increase the linear flow rate in the nozzle 3a.

The injection fluid discharged by pressure to the liquid flow A in the flow channel B causes an injector effect, whereby the solution coming from the feed pipe 9b for the additive 9 is entrained in the injection fluid. Flowing at a sufficient rate transversely to the flow direction of the liquid flow, the injection fluid is effectively mixed with the flow of the solution at the cross-section of the liquid flow A at the feed means 3a. The area where the intensive mixing takes place is marked by broken lines in FIG. 2. The feed pressure of the injection fluid is preferably adjusted to be such that the rate at which the injection fluid and the additive 9 are injected to the flow A, is at least three times, advantageously at least five times the flow rate of the liquid flow A in the pipe B. An arrangement similar to that shown in FIG. 2 can be provided at one or more successive feed points. If there are two or more successive dosing points 3 for the additive 9, such as nanocellulose, in the flow direction of the liquid flow A, said additive 9 can be dosed in small portions. It is thus possible to improve the overall efficiency by a relatively simple construction.

In an advantageous example, one or more additives are added in the way according to the invention by injecting said one or more additives to the liquid flow A. When one or more additives are added in the way according to the invention by injection, said one or more additives can be added, for example, at the same injection point as nanocellulose, and/or at a separate injection point. Thanks to the effective mixing according to the invention, said one or more additives are effectively mixed with the cement-like composition, such as concrete mixture and/or cement, wherein it may be possible to decrease the quantities of additives needed.

According to an advantageous example, the liquid flow A, to which at least one additive is injected, may also contain additives.

In an advantageous example, the apparatus according to the invention comprises a dosing unit 9c for additive 9. Thus, according to an advantageous example, the following data are entered in the dosing unit 9c:
the size of the additive batch to be prepared, such as the size of the nanocellulose batch;
the desired additive content, for example, nanocellulose content, of the cement-like composition 7, such as concrete mixture; and
the dry content of the additive to be fed to the dosing point 3, for example the consistency of nanocellulose.

According to the these predetermined parameters, the dosing unit 9c will dose a quantity of the additive 9 to the manufacturing process of the cement-like composition 7. Preferably, the dosing takes place by controlling the flow in the additive feed line 9b.

According to an advantageous example, when the additive dosing unit 9c is used, at least the flow in the feed line is preferably measured from the additive flow line 9b. When nanocellulose is used as at least one additive, the nanocellulose preferably has a predetermined solids content. If necessary, the solids content of nanocellulose can be monitored by taking separate samples from, for example, the container containing nanocellulose.

A sufficient feed rate of additive 9 in the feed line 9b can be achieved, for example, with a pump pumping said additive 9 (not shown in the figures). The additive dosage is preferably controlled on the basis of the flow in the feed line.

The liquid flow A, to which the additive 9 has been mixed, is led downstream of the dosing and mixing point 3, to be added to a cement-like composition by means 1 for preparing the cement-like composition. It is also possible to apply a separate intermediate container (not shown in the drawings) before adding said additive 9 to the cement-like composition, such as a concrete mixture. Thus, the contents of the intermediate container are mixed preferably continuously with a mixer. The prepared mixture of additive and liquid, preferably nanocellulose and liquid, is used to replace at least part of the water used in the manufacture of the cement-like composition.

In the following, we will present experiments carried out in practice, demonstrating advantages resulting particularly from the addition of a nanocellulose additive. Furthermore, we have compared efficient mixing of the nanocellulose additive to the mixing effect of prior art. Test runs carried out under laboratory conditions will be described in more detail in the following examples 1 to 3. In the examples, we have used the abbreviation “w/c” for the water/cement ratio. As the additive, we have used nanocellulose, abbreviated MFC.

### Examples 1 and 2

### Materials Used

### Nanocelluloses:

1) Microfibrillar cellulose of technical quality, or so-called technical MFC. The term “technical MFC” refers, in this application, to refined and fractionated pulp which has been obtained by removing larger cellulose fibres from the refined pulp by fractionation, for example with a filter cloth or a filter membrane. The technical MFC does not contain large fibres, such as fibres with a diameter larger than 15 μm.

2) Microfibrillar cellulose L1, or so-called MFC-L1. The term MFC-L refers, in this application, to material whose labilization is based on the oxidation of pulp, cellulose raw material or refined pulp. Because of the labilization, the pulp can be easily disintegrated to microfibrillar cellulose. As a result of the labilization reaction, functional aldehydic and carboxylic acid groups are found on the surfaces of the MFC-L1 fibres.

3) Microfibrillar cellulose L2, or so-called MFC-L2. The term MFC-L2 refers, in this application, to material whose labilization is based on the carboxymethylation of pulp, cellulose raw material or refined pulp. Because of the labilization, the pulp can be easily disintegrated to microfibrillar cellulose. Functional carboxyl groups are found on the surfaces of MFC-L2 fibres.

In addition to the nanocellulose additive samples, reference samples were prepared, to which no nanocellulose had been added. These are called “reference” and “control” further below in this application and in the drawings 3 to 12.

### Cement:

The cement used in all the test points was CEM II/A-M(S-LL) 42.5 N cement (Finnsementti Oy, Finland).

### Example 1

In the test run, rheology of the paste mixture was examined for the cellulose materials used, that is

1) technical MFC,

### 2) MFC-L1, and

### 3) MFC-L2.

### Methods:

### Mixing

The mixing of the paste was carried out by a Hobart mortar mixer. The mixing time was three minutes (two minutes at low speed+one minute at high speed). The pulp and cellulose material were first mixed manually with water (and possible plasticizer) by using a beater.

### Rheology

The rheology of the paste mixture was examined by viscosimeter (Rheotest RN4). After the mixing, the paste was added to a coaxial cylinder for measurement. The shear speed was varied, and the shear stress of the samples was measured.

### Test Plan:

The compositions of the paste mixtures are shown in Table 1. The water/cement ratios of the pastes prepared were adjusted so that the processibility of all the pastes became equal. This corresponds to almost constant yield limits.

TABLE 1
Compositions and corresponding rheology results of past mixtures

| | Dose | | | | |
|---|---|---|---|---|---|
| | | m(plasti- | | Yield | |
| Sample | m(additive)/ | cizer)/ | m(water)/ | limit | Viscosity |
| (additive) | m(cement) | m(cement) | m(cement) | (Pa) | (Pa s) |
| Control | 0.00% | | 0.40 | 231 | 0.30 |
| Technical | 0.13% | | 0.47 | 220 | 0.19 |
| MFC | | | | | |
| Technical | 0.25% | | 0.54 | 197 | 0.13 |
| MFC | | | | | |
| Technical | 0.50% | | 0.64 | 177 | 0.09 |
| MFC | | | | | |
| Technical | 1.00% | | 0.80 | 199 | 0.07 |
| MFC | | | | | |
| MFC-L1 | 0.25% | | 0.54 | 185 | 0.28 |
| MFC-L2 | 0.06% | | 0.47 | 244 | 0.19 |
| MFC-L2 | 0.13% | | 0.52 | 252 | 0.18 |
| MFC-L2 | 0.25% | | 0.59 | 253 | 0.13 |
| MFC-L2 | 0.50% | | 0.75 | 266 | 0.08 |
| Control | 0.00% | 0.09% | 0.36 | 276 | 0.63 |
| Technical | 0.25% | 0.09% | 0.48 | 167 | 0.27 |
| MFC | | | | | |
| Technical | 0.50% | 0.09% | 0.61 | 135 | 0.14 |
| MFC | | | | | |
| Technical | 1.00% | 0.09% | 0.73 | 245 | 0.12 |
| MFC | | | | | |
| MFC-L1 | 0.25% | 0.09% | 0.44 | 281 | 0.46 |
| MFC-L2 | 0.25% | 0.09% | 0.54 | 321 | 0.26 |

The rheology of the paste mixtures was examined immediately after the mixing. The test was taken in about 15 minutes.

### Test Results:

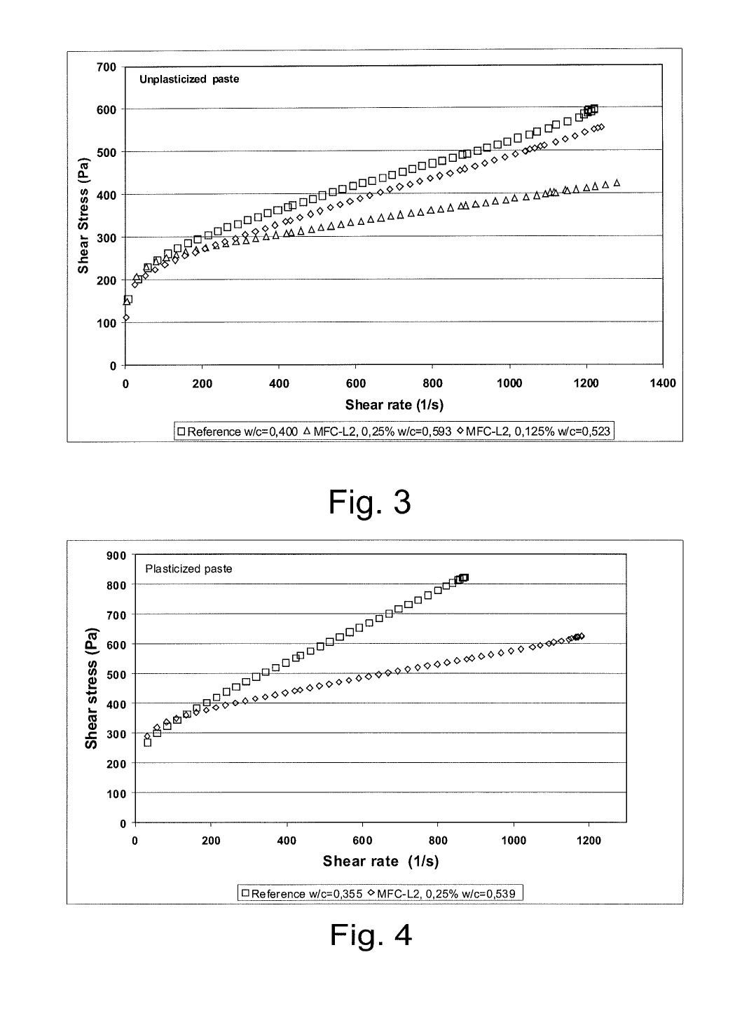

The test results are shown in the above Table 1 and FIGS. 3 and 4. The test runs showed that when nanocellulose (MFC) is used as an additive, it is possible to prepare pastes with a much higher water/cement ratio in such a way that their processability and stability remain the same, compared with the reference sample. In the example, for the reference paste, a higher cement content was used to achieve a suitable processability. In the test run, also an effect increasing the yield limit was observed.

FIG. 3 shows the shear stress (Pa) of paste formed without a plasticizer, in relation to the shear speed (1/s). The water/cement ratios (w/c) for the reference sample, the sample MFC-L2 0.25%, and the sample MFC-L2 0.125% were: 0.400, 0.593 and 0.539, respectively.

FIG. 4 shows the shear stress (Pa) of paste formed with a plasticizer, in relation to the shear speed (1/s). The water/cement ratios (w/c) for the reference sample and the sample MFC-L2 0.25% were 0.355 and 0.539, respectively.

### Example 2

In the test run, studies on segregation of water from the injection mortar, and viscosity studies were carried out by applying technical microfibrillar cellulose and MFC-L1 preparation.

### Methods:

### Mixing

The injection mortar was mixed with a high-speed mixer (Desoi AKM-70D). The mixing of cement, water, and cellulose was always carried out at the speed of 5000 rpm. The water was added first, then the cellulose after short premixing (shorter than 5 s), and finally the cement. The mixing time of the cement was two minutes. In some cases, the cellulose was premixed (or dispersed) for two minutes at 5,000 or 10,000 rpm.

### Methods for Testing Fresh Injection Mortar

The segregation of water was measured by pouring one (1) liter of mortar into a measuring beaker (volume 1,000 ml and diameter 60 mm) and by measuring the quantity of water segregated after two hours.

Marsh viscosity was measured according to the standard (EN 14117) by applying a Marsh funnel.

### Test Plan and Results

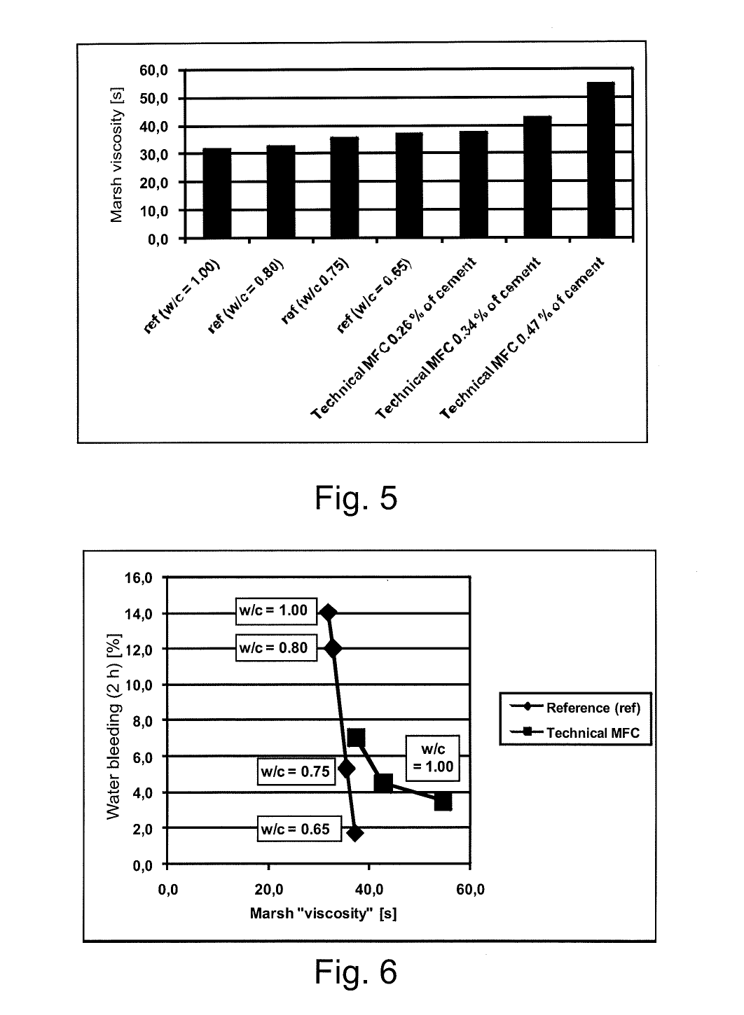

The compositions and test results for control mixtures of injection mortars and for mixtures containing technical microfibrillar cellulose (technical MFC) are shown in Table 2 and in FIGS. 5 to 7.

TABLE 2
Compositions of injection mortar mixtures containing technical
microfibrillar cellulose (technical MFC) (control = ctrl).

| | Control | | | | Technical MFC | | |
|---|---|---|---|---|---|---|---|
| | Ctrl 1 | Ctrl 2 | Ctrl 3 | Ctrl 4 | Mix 1 | Mix 2 | Mix 3 |
| Dry material content | — | — | — | — | 3.81 | 3.81 | 3.81 |
| of cellulose product | | | | | | | |
| (%) | | | | | | | |
| Water content of cellulose | — | — | — | — | 96.19 | 96.19 | 96.19 |
| product (%) | | | | | | | |
| Cement (kg/m³) | 756 | 891 | 932 | 1028 | 755 | 754 | 754 |
| Total water (kg/m³) | 756 | 713 | 699 | 668 | 755 | 754 | 754 |
| Cellulose product | 0 | 0 | 0 | 0 | 52.10 | 67.29 | 92.94 |
| containing water | | | | | | | |
| (kg/m³) | | | | | | | |
| Dry content of cellulose | 0 | 0 | 0 | 0 | 1.99 | 2.57 | 3.54 |
| product (kg/m³) | | | | | | | |
| Water of cellulose | 0 | 0 | 0 | 0 | 50.11 | 64.72 | 89.40 |
| product (kg/m³) | | | | | | | |
| Dry cellulose | 0 | 0 | 0 | 0 | 0.263 | 0.340 | 0.470 |
| (% of cement) | | | | | | | |
| Dry cellulose | 0 | 0 | 0 | 0 | 0.263 | 0.340 | 0.470 |
| (% of water) | | | | | | | |
| w/c ratio | 1.00 | 0.80 | 0.75 | 0.65 | 1.00 | 1.00 | 1.00 |
| Mixing temperature | 25.2 | 24.9 | 23.2 | 24.7 | 24.5 | 23.3 | 23.6 |
| (° C.) | | | | | | | |
| Marsh viscosity (s) | 31.9 | 32.8 | 35.4 | 37.2 | 37.4 | 42.7 | 54.5 |
| Segregation of water | — | — | — | — | — | — | — |
| (%) | | | | | | | |
| at a time point (h) | — | — | — | — | — | — | — |
| 0.00 | 0 | 0 | 0 | 0 | 0 | 0 | 0 |
| 0.75 | 5.0 | 6.5 | 2.8 | 1.0 | 3.0 | 2.2 | 1.8 |
| 1.00 | 10.0 | 10.0 | 4 | 1.3 | 4.0 | 2.8 | 2.3 |
| 2.00 | 14.0 | 12.0 | 5.3 | 1.7 | 7.0 | 4.5 | 3.5 |

FIG. 5 shows the segregation of water (after two hours) for control mixtures whose w/c ratios range from 0.65 to 1.00, and for mixtures containing cellulose fibres (technical MFC) whose w/c ratio is always 1.00.

FIG. 6 shows the Marsh viscosity values for control mixtures whose w/c ratios range from 0.65 to 1.00, and for mixtures containing cellulose fibres (technical MFC) whose w/c ratio is always 1.00.

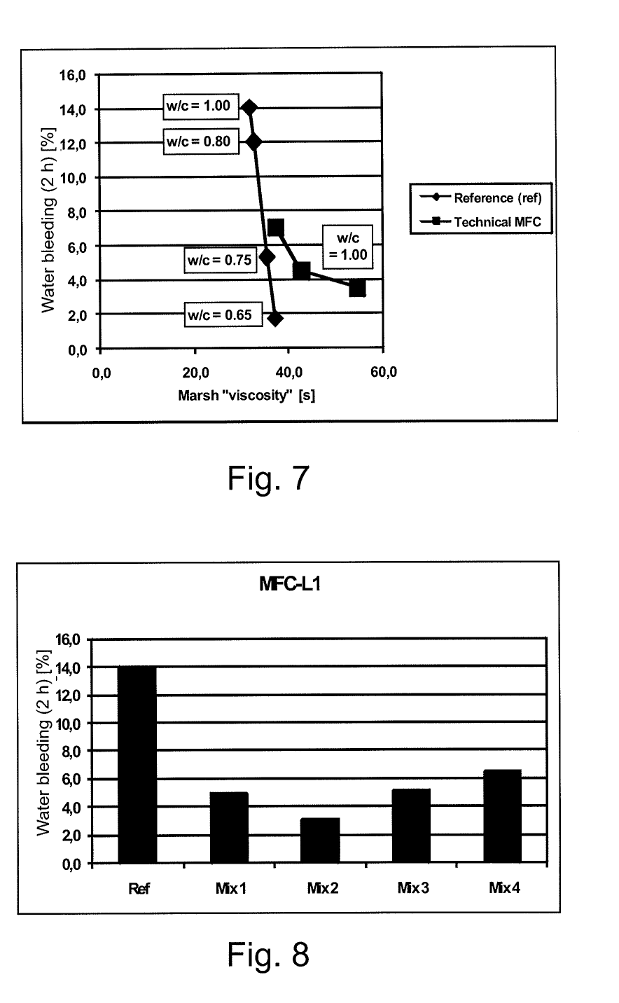

FIG. 7 shows the Marsh viscosity values for control mixtures whose w/c ratios range from 0.65 to 1.00, and for mixtures containing cellulose fibres (technical MFC) whose w/c ratio is always 1.00.

The compositions for injection mortar mixtures, which contain microfibrillar cellulose fibres obtained from labilized pulp (MFC-L1), are shown in Table 3 and in FIGS. 8 to 10. Three mixtures (mixtures 2, 3 and 4) were subjected to premixing (or dispersion) of cellulose for two minutes at 5,000 or 10,000 rpm.

The mixtures shown in Table 3 were mixed and premixed with water in only the following way:

Control sample: First water+cement+mixing (5,000 rpm, two minutes).

Mixture 1: Control (w/c ratio=1.00)—Water and cement were mixed at 5,000 rpm for one minute. Cellulose was added to the mixture, and the mixing was continued at 5,000 rpm for two minutes.

Mixture 2: Dry cellulose 0.100% of cement—Cellulose and water were mixed at 5,000 rpm for two minutes. Cement was added to the mixture, and the mixing was continued at 5,000 rpm for two minutes.

Mixture 3: Dry cellulose 0.05% of cement—Cellulose and water were mixed at 10,000 rpm for two minutes. Cement was added to the mixture, and the mixing was continued at 5,000 rpm for two minutes.

Mixture 4: Dry cellulose 0.05% of cement—Cellulose and water were mixed at 5,000 rpm for two minutes. Cement was added to the mixture, and the mixing was continued at 5,000 rpm for two minutes.

TABLE 3
Compositions of injection mortar mixtures containing microfibrillar
cellulose fibres obtained from labilized pulp (MFC-L1).

| | | MFC-L1 | | | |
|---|---|---|---|---|---|
| | Ctrl | Mix 1 | Mix 2 | Mix 3 | Mix 4 |
| Dry material | — | 0.99 | 0.99 | 0.99 | 0.99 |
| content of | | | | | |
| cellulose | | | | | |
| product (%) | | | | | |
| Water content | — | 99.01 | 99.01 | 99.01 | 99.01 |
| of cellulose | | | | | |
| product (%) | | | | | |
| Cement (kg/m³) | 756 | 756 | 756 | 756 | 756 |
| Total water (kg/m³) | 756 | 756 | 756 | 756 | 756 |
| Cellulose product | 0 | 76.29 | 76.29 | 38.15 | 38.15 |
| containing water | | | | | |
| (kg/m³) | | | | | |
| Dry content of | 0 | 0.76 | 0.76 | 0.38 | 0.38 |
| cellulose product | | | | | |
| (kg/m³) | | | | | |
| Water of cellulose | 0 | 75.54 | 75.54 | 37.77 | 37.77 |
| product (kg/m³) | | | | | |
| Dry cellulose | 0 | 0.100 | 0.100 | 0.050 | 0.050 |
| (% of cement) | | | | | |
| Dry cellulose | 0 | 0.100 | 0.100 | 0.050 | 0.050 |
| (% of water) | | | | | |
| w/c ratio | 1.00 | 1.00 | 1.00 | 1.00 | 1.00 |
| Mixing temperature | 25.2 | 23.5 | 24 | 25.6 | 24.3 |
| (° C.) | | | | | |
| Marsh viscosity (s) | 31.9 | 38.5 | 50.3 | 38.2 | 38.8 |
| Segregation of | — | — | — | — | — |
| water (%) | | | | | |
| at a time point (h) | — | | — | — | — |
| 0.0 | 0 | 0.0 | 0.0 | 0.0 | 0.0 |
| 0.8 | 5.0 | 2.5 | 2.0 | 3.0 | 3.8 |
| 1.0 | 10.0 | 3.0 | 2.2 | 3.8 | 5.0 |
| 2.0 | 14.0 | 5.0 | 3.1 | 5.2 | 6.5 |

FIG. 8 shows the segregation of water (after two hours) for a control mixture whose w/c ratio is 1.00, and for mixtures containing cellulose fibres (MFC-L1) whose w/c ratio is also 1.00.

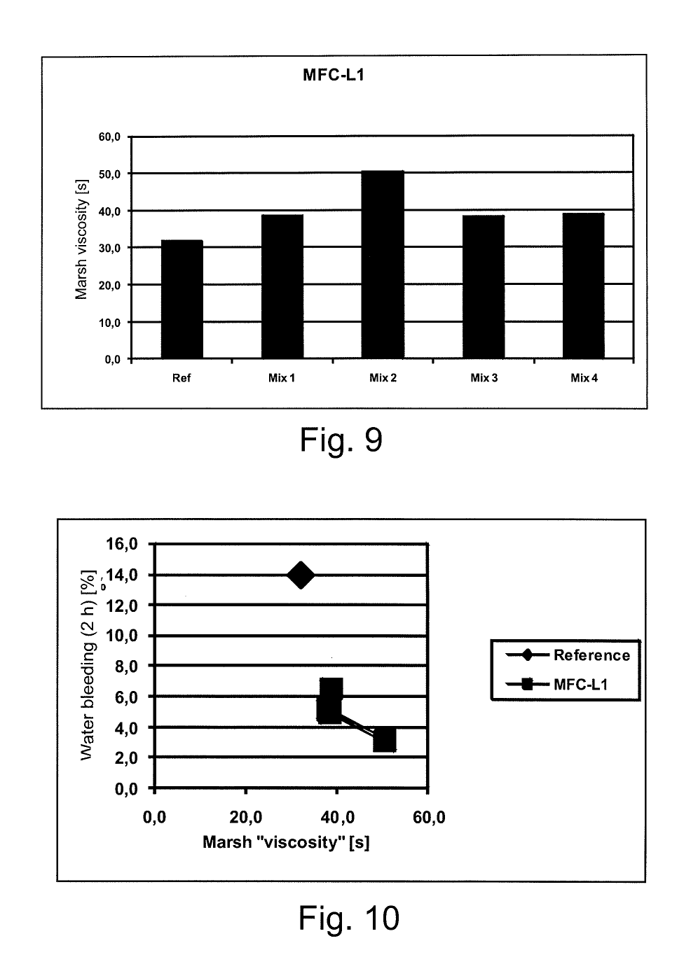

FIG. 9 shows the Marsh viscosity values for a control mixture whose w/c ratio is 1.00, and for mixtures containing cellulose fibres (MFC-L1) whose w/c ratio is also 1.00.

FIG. 10 shows the Marsh viscosity values and water segregation values for a control mixture and mixtures containing cellulose (MFC-L1). All the mixtures have a w/c ratio of 1.00.

### Summary of the Results of Examples 1 and 2

Experiments carried out in practice showed that microfibrillar cellulose fibres reduced the segregation of water from the injection mortar and increased its viscosity. The relative increase in Marsh viscosity was lower than the relative decrease in the segregation of water, for example 17% vs. 50% (technical MFC preparation of 0.263% of cement, when the w/c ratio is 1.00), and for example 20% vs. 63% (MFC-L1 preparation of 0.05% of cement, when the w/c ratio is 1.00).

The water segregation tests showed that microfibrillar cellulose fibres reduced the segregation of water from mortar having a w/c ratio of 1.00, to the level of a control mixture having a lower w/c ratio. For example, cellulose fibres (technical MFC) whose a content was 0.34 weight percent of dry cement and where the w/c ratio of the mixture was 1.00, produced an approximately as low water segregation as a control mixture having a w/c ratio of 0.75.

On the basis of the Marsh viscosity tests, it can be concluded that the microfibrillar cellulose fibres increase the viscosity of mortar having a w/c ratio of 1.00 to the level of a control mixture having a lower w/c ratio. The increase in the Marsh viscosity depends on the quantity of cellulose fibres added. If the increased nanocellulose content is not sufficiently high, the increase in viscosity will be low.

### Example 3

The manufacture of microfibrillar cellulose from labilized pulp during the preparation of mortar.

The microfibrillar cellulose additive can be made from labilized pulp during the preparation of a wet cement-containing formulation by an apparatus which is typically used in the industry. For example, high-speed mixers, such as Desoi AKM-70D, are commonly used for homogenizing injection mortars. This example shows how mixers of this type can be used according to the invention for fibrillating labile pulp into a very effective additive.

### Test Plan and Results

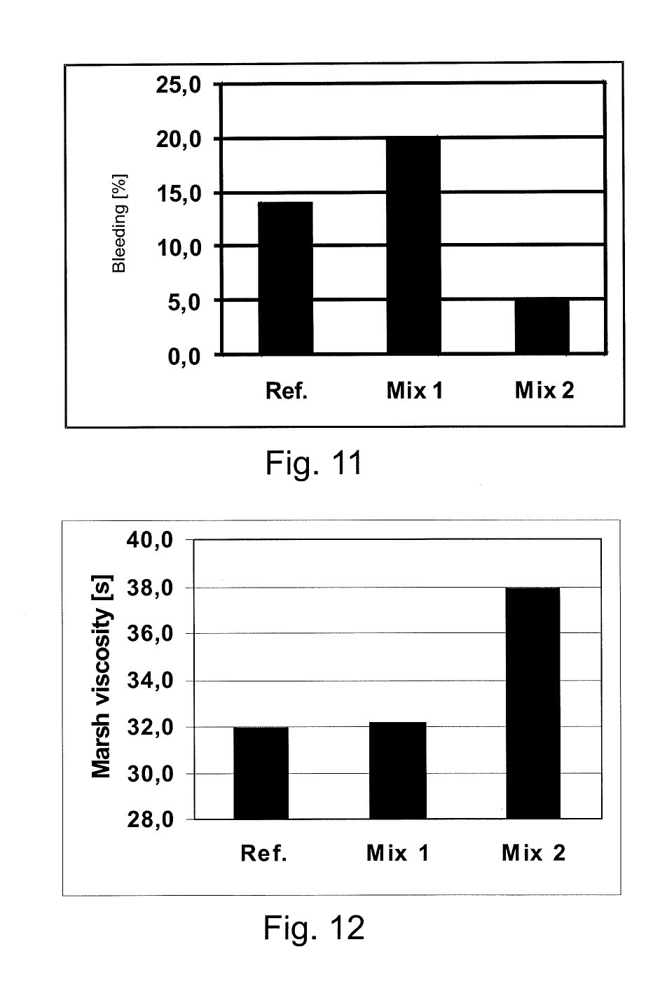

The compositions and the test results for injection mortar mixtures, in which chemically modified pulp was used, that is, the same pulp that was used for preparing MFC-L1, with and without predispersion, is shown in Table 4 and in FIGS. 11 and 12. A reference sample without cellulose is also included in the results.

TABLE 4
Injection mortar compositions with and without labile
chemically modified pulp (precursor for MFC-L1 preparation),
as well as with and without predispersion.

| | Control | Mix 1 | Mix 2 |
|---|---|---|---|
| Predispersion | — | no | yes |
| (10,000 rpm) | | | |
| Dry material | — | 2.68 | 1.00 |
| content of | | | |
| cellulose | | | |
| product (%) | | | |
| Water content | — | 97.32 | 99.00 |
| of cellulose | | | |
| product (%) | | | |
| Cement (kg/m³) | 756 | 756 | 756 |
| Total water (kg/m³) | 756 | 756 | 756 |
| Cellulose product | 0 | 36.65 | 98.25 |
| containing water | | | |
| (kg/m³) | | | |
| Dry content of | 0.00 | 0.98 | 0.98 |
| cellulose product | | | |
| (kg/m³) | | | |
| Water of cellulose | 0.00 | 35.67 | 97.27 |
| product (kg/m³) | | | |
| Dry cellulose | 0.00 | 0.130 | 0.130 |
| (% of cement) | | | |
| Dry cellulose | 0.000 | 0.130 | 0.130 |
| (% of water) | | | |
| w/c ratio | 1.00 | 1.00 | 1.00 |
| Mixing temperature | 25.2 | 23 | 23.1 |
| (° C.) | | | |
| Marsh viscosity (s) | 31.9 | 32.12 | 37.9 |
| Segregation of | — | — | — |
| water (%) | | | |
| at a time point (h) | — | — | — |
| 0.0 | 0.0 | 0 | 0 |
| 0.8 | 5.0 | 15.2 | 2.5 |
| 1.0 | 10.0 | 17 | 3 |
| 2.0 | 14.0 | 20 | 4.9 |

FIG. 11 shows the segregation of water (after two hours) for a control mixture having a w/c ratio of 1.00, and for a mixture containing labile pulp (mixture 1, MFC-L1 precursor) and for a MFC-L1 preparation mixture fibrillated by using a Desoi AKM-70D mixer (mixture 2), also having a w/c ratio of 1.00.

FIG. 12 shows the Marsh viscosity values for a control mixture having a w/c ratio of 1.00, and for a mixture containing labile pulp (mixture 1, MFC-L1 precursor) and for a MFC-L1 preparation mixture fibrillated by using a Desoi AKM-70D mixer (mixture 2), also having a w/c ratio of 1.00.

In predispersion, the content of dry matter (dry labile pulp) was 1% in water. The predispersion was carried out with a high-speed mixer (Desoi AKM-70D) at 10,000 rpm. The obtained predispersed pulp having a dry content of 1% was used for preparing injection mortar.

The mixing (premixed or non-premixed) of cement, water, and cellulose was carried out at the speed of 5000 rpm. The water was added first, then the cellulose after short premixing (shorter than 5 s), and finally the cement. The mixing time of the cement was two minutes.

The tests showed that predispersed labile chemically modified pulp reduced the segregation of water and increased the Marsh viscosity of injection mortar. Without predispersion, the segregation of water was not reduced nor the Marsh viscosity increased.

The water segregation tests showed that predispersed labile chemically modified pulp reduced the segregation of water by 65 percent from mortar having a w/c ratio of 1.00.

On the basis of the Marsh viscosity tests, it can be concluded that the predispersed labile chemically modified pulp increased the viscosity of mortar having a w/c ratio of 1.00 by about 19 percent.

As can be observed from the above examples, the results were considerably better when the mixing efficiency according to the invention was provided, and the properties of the cement were substantially improved as the mixing of nanocellulose with the cement was improved. The present invention discloses a new industrially applicable method and apparatus for mixing an additive evenly to a cement-like composition, such as a concrete mixture and/or cement.

The uniform addition of nanocellulose into a cement-like composition, such as a concrete mixture and/or cement, is particularly important, because uneven mixing will cause a situation in which the weakest point of the concrete mixture and/or cement determines the strength of the concrete.

Thanks to the present industrially applicable method and apparatus, it is possible to admix nanocellulose to a cement-like composition in such a way that the properties of the manufactured concrete mixture, for example, can be substantially improved.

The invention is not limited solely to the examples presented in FIGS. 1 to 12 and in the above description, but the invention is characterized in what will be presented in the following claims.

1-15. (canceled)

16. A method for adding an additive to a cement-like composition, the method comprising:
forming a liquid flow,
supplying additive to the system, wherein the additive comprises nanocellulose, by means of an injection fluid forming a side flow,
dosing said additive to said liquid flow by supplying it to the liquid flow substantially transversely to the flowing direction of said liquid flow, in such a way that a mixture is formed which comprises said additive and liquid,
discharging the injection fluid to the liquid flow, and
adding the formed mixture as an additive to a cement-like composition in such a way that such that
the rate at which the additive is fed to the liquid flow, is at least three times the flow rate of the liquid flow; wherein
the side flow is smaller than 10 volume percent (vol %) of the total flow of the liquid to be processed.

17. The method of claim 16, wherein the injection fluid comprises the same substance as the fluid of the liquid flow and is a side flow taken from the liquid flow and led back to the liquid flow.

18. The method according to claim 16, comprising leading said nanocellulose by means of a feed line to said liquid flow, wherein the dry content of nanocellulose in said feed line is lower than 10%.

19. The method according to the claim 16, wherein the content of nanocellulose in finished cement is at least 0.002 wt-%.

20. The method according to claim 19, wherein the content of nanocellulose in finished cement is not higher than 2 wt-%.

21. The method according to claim 19, wherein the content of nanocellulose in finished cement is not higher than 0.2 wt-%.

22. The method according to claim 19, wherein the content of nanocellulose in finished cement is not higher than 0.05 wt-%.

23. The method according to the claim 16, wherein the cement-like composition used in the method is a concrete mixture.

24. The method according to the claim 16, wherein the liquid flow used in the method is a water flow.

25. An apparatus for adding an additive to a cement-like composition, comprising:
a liquid flow channel,
means for supplying additive to said liquid flow channel,
a dosing point in said flow channel, comprising one or more feeding means opening into the flow channel and directed substantially transversely to the flow direction of the liquid flow intended for the liquid flow channel, and arranged to feed said additive in such a way that the additive is mixed to the flow at the dosing point to form a mixture comprising additive and liquid,
mixing means for mixing the mixture to a cement-like composition, and
an injection fluid feed channel for feeding injection fluid, wherein the injection fluid feed channel is a side flow which is separated from the liquid flow, and is recombined with the liquid flow at the dosing point.

26. The apparatus of claim 25, comprising:
a pump in the injection fluid feed channel.

27. The apparatus according to claim 25, comprising an additive dosing container, wherein said one or more feed means are connected to the additive dosing container.

28. The apparatus of claim 25, comprising an additive dosing unit which is arranged to determine the quantity of the additive to be dosed on the basis of predetermined parameters which comprise at least one of the following target values:
target solids content of the additive to be fed to the dosing point,
target quantity of nanocellulose to be fed to the dosing point, and
target additive content for the cement-like composition to be prepared.

29. A method for adding an additive to a cement-like composition, wherein the method comprises:
forming a liquid flow,
supplying additive to the system, wherein the additive comprises nanocellulose, by means of an injection fluid forming a side flow,
dosing said additive to said liquid flow by feeding it to the liquid flow counter-currently to the flowing direction of said liquid flow, in such a way that a mixture is formed which comprises said additive and liquid,
discharging the injection fluid to the liquid flow, and
adding the formed mixture as an additive to a cement-like composition in such a way that such that
the rate at which the additive is fed to the liquid flow, is at least three times the flow rate of the liquid flow; wherein
the side flow is smaller than 10 volume percent (vol %) of the total flow of the liquid to be processed.

30. The method according to claim 29, wherein the injection fluid comprises the same substance as the fluid of the liquid flow and is a side flow taken from the liquid flow and led back to the liquid flow.
